(19) United States
(12) Patent Application Publication
(10) Pub. No.: US 2025/0181379 A1
(43) Pub. Date: Jun. 5, 2025

(54) TIME SERIES MODEL TRAINING METHODS AND APPARATUSES, AND MEMORY MANAGEMENT METHODS AND APPARATUSES

(71) Applicant: Alipay ( Hangzhou ) Information Technology Co., Ltd., Hangzhou (CN)

(72) Inventor: Guangjie ZHENG, Hangzhou (CN)

(21) Appl. No.: 18/968,464

(22) Filed: Dec. 4, 2024

(30) Foreign Application Priority Data
Dec. 5, 2023 (CN) 202311658915.7

(51) Int. Cl. G06F 9/455

(52) U.S. Cl. CPC G06F 9/45558; G06F 2009/45583

(57) ABSTRACT

A time series model training method, includes: obtaining a historical memory sequence collected by using a memory management module, wherein the historical memory sequence includes a plurality of memory use amounts arranged in a time sequence, each memory use amount is a maximum memory use amount in a corresponding time period, and the maximum memory use amount is obtained through collection for an off-heap memory of a Java virtual machine; and training a time series model based on the historical memory sequence, to obtain the trained time series model to forecast a memory use amount in a future time period.

### CROSS-REFERENCE TO RELATED APPLICATIONS

The present application is based upon and claims priority to Chinese Patent Application No. 202311658915.7, filed on Dec. 5, 2023, the content of which is incorporated herein by reference in its entirety.

### TECHNICAL FIELD

Embodiments of this specification relate to the field of computer technologies, and in particular, to time series model training methods and apparatuses, memory management methods and apparatuses, computer-readable storage media, and computing devices.

### BACKGROUND

A Java virtual machine (JVM) is crucial for running a Java program, so that Java has a feature of “write once, run anywhere”. A bytecode (.class) file of the Java program can run on any platform provided that a Java virtual machine for the platform is installed on the platform.

A Java process memory includes an on-heap memory and an off-heap memory. However, at present, management of the off-heap memory by an operating system can hardly satisfy a high requirement in a real use scenario. In view of this, a solution is urgently needed, to improve management efficiency of the off-heap memory.

### SUMMARY

Embodiments of this specification provide time series model training methods and apparatuses, and memory management methods and apparatuses, so that elastic scaling can be implemented for memory allocation, thereby effectively improving memory management efficiency.

According to a first aspect, a time series model training method is provided. The method includes: obtaining a historical memory sequence collected by using a memory management module, where the historical memory sequence includes a plurality of memory use amounts arranged in a time sequence, each memory use amount is a maximum memory use amount in a corresponding time period, and the maximum memory use amount is obtained through collection for an off-heap memory of a Java virtual machine; and training a time series model based on the historical memory sequence, to obtain the trained time series model to forecast a memory use amount in a future time period.

According to a second aspect, a memory management method is provided, including: obtaining a target memory sequence collected by using a memory management module, where the target memory sequence includes T memory use amounts that correspond to T time periods and that are arranged in a time sequence, each memory use amount is a maximum memory use amount in a corresponding time period, and the maximum memory use amount is obtained through collection for an off-heap memory of a Java virtual machine; performing forecasting processing based on the target memory sequence by using a trained time series model, to obtain a forecasted memory use amount in each time period in a future (T+1)^{th} time period to a future (T+t)^{th} time period; and adjusting a memory in advance based on the forecasted memory use amount and a corresponding time period by using the memory management module, where T is an integer greater than or equal to 2, and t is an integer greater than or equal to 1.

According to a third aspect, a time series model training apparatus is provided. The apparatus includes: one or more processors; and one or more memories storing instructions executable by the one or more processors. The one or more processors are configured to obtain a historical memory sequence collected by using a memory management module, where the historical memory sequence includes a plurality of memory use amounts arranged in a time sequence, each memory use amount is a maximum memory use amount in a corresponding time period, and the maximum memory use amount is obtained through collection for an off-heap memory of a Java virtual machine; and train a time series model based on the historical memory sequence, to obtain the trained time series model to forecast a memory use amount in a future time period.

According to a fourth aspect, a memory management apparatus is provided, including: one or more processors; and one or more memories storing instructions executable by the one or more processors. The one or more processors are configured to obtain a target memory sequence collected by using a memory management module, where the target memory sequence includes T memory use amounts that correspond to T time periods and that are arranged in a time sequence, each memory use amount is a maximum memory use amount in a corresponding time period, and the maximum memory use amount is obtained through collection for an off-heap memory of a Java virtual machine; perform forecasting processing based on the target memory sequence by using a trained time series model, to obtain a forecasted memory use amount in each time period in a future (T+1)^{th} time period to a future (T+t)^{th} time period; and adjust a memory in advance based on the forecasted memory use amount and a corresponding time period by using the memory management module, where T is an integer greater than or equal to 2, and t is an integer greater than or equal to 1.

### BRIEF DESCRIPTION OF DRAWINGS

The following briefly describes the accompanying drawings of the present disclosure. The accompanying drawings in the following descriptions show merely example embodiments of this disclosure.

FIG. 1 is a schematic diagram illustrating a management architecture of an off-heap memory and an on-heap memory of a Java virtual machine, according to an embodiment.

FIG. 2 is an architectural diagram illustrating an implementation scenario of a memory management method, according to an embodiment.

FIG. 3 is a flowchart illustrating a time series model training method, according to an embodiment.

FIG. 4 is a flowchart illustrating a procedure for training a time series model, according to an embodiment.

FIG. 5 is a schematic diagram illustrating a memory management method, according to an embodiment.

FIG. 6 is a schematic diagram illustrating a time series model training apparatus, according to an embodiment.

FIG. 7 is a schematic diagram illustrating a memory management apparatus, according to an embodiment.

FIG. 8 is a schematic diagram illustrating an apparatus, according to an embodiment.

### DETAILED DESCRIPTION OF EMBODIMENTS

Reference will now be made in detail to embodiments, examples of which are illustrated in the accompanying drawings. The following description refers to the accompanying drawings in which the same numbers in different drawings represent the same or similar elements unless otherwise represented. The described embodiments are merely examples rather than all the embodiments of the present disclosure.

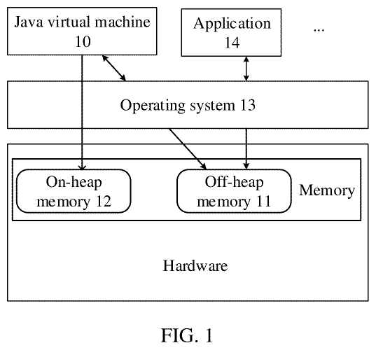

FIG. 1 is a schematic diagram illustrating a management architecture of an off-heap memory 11 and an on-heap memory 12 of a Java virtual machine (JVM) 10, according to an embodiment. As shown in FIG. 1, the on-heap memory 12 is controlled by the JVM 10, and the off-heap memory 11 can store instances of some objects that are allocated to a memory area outside the on-heap memory 12 of the JVM 10, Because the memory area is directly managed by an operating system 13 (instead of the JVM 10), another process and device (for example, a GPU or an application 14) can directly access the memory area by using the operating system 13, to reduce a process of copying memory data from the JVM 10.

In a real use scenario, however, management of an off-heap memory by an operating system may not satisfy a high requirement. For example, in a Flink off-heap memory management manner, an off-heap memory with a fixed size is applied for in advance and allocated to each specific module, for example, a network memory, a task memory, or a framework memory, and a size of each module is set based on a specific parameter. In the Flink off-heap memory management manner, the size of each module needs to be set based on a separate parameter, which may pose a challenge to parameter setting rationality; off-heap memories of all modules are isolated from each other, and cannot be shared; and a whole size is fixed, and dynamic scaling cannot be performed.

For another example, in a Spark off-heap memory management manner, a Spark off-heap memory includes a storage memory and an execution memory, and mutual occupation of modules is controlled based on a dynamic occupation mechanism, to improve utilization of memory resources to some extent. In the Spark off-heap memory management manner, interaction is directly performed with a system underlying layer each time the off-heap memory is applied for and freed, and efficiency is low; and the most proper parameter cannot be given for a size of the off-heap memory.

In view of the above, embodiments of this specification further provide an elastic memory scaling solution based on inferential statistics. Modeling is performed for collected memory time series data, to obtain a memory use status in a future period of time, so as to help a memory management module implement dynamic scaling, thereby effectively improving management efficiency of an off-heap memory.

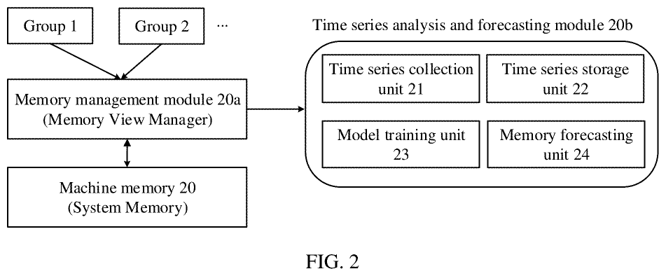

FIG. 2 is an architectural diagram illustrating an implementation scenario of a memory management method, according to an embodiment. As shown in FIG. 2, a memory management module 20a (e.g., a Memory View Manager) in a machine system manages application for, and freeing of, memory areas in a machine memory (system memory) 20, such as all off-heap memories in a process. A group 1 and a group 2 indicate a basic grouping unit, for example, a memory page used for the off-heap memory.

The memory management method is implemented by a newly designed time series analysis and forecasting module 20b based on memory use data in the memory management module 20a. For example, the time series analysis and forecasting module 20b includes a time series collection unit 21, a time series storage unit 22, a model training unit 23, and a memory forecasting unit 24. The time series collection unit 21 is configured to obtain memory use data from the memory management module 20a to construct a historical memory sequence. The time series storage unit 22 is configured to store, on a local disk, data collected by the time series collection unit 21. The model training unit 23 is configured to read data in the time series storage unit 22 to construct a time series forecasting model (also referred to as a time series model). The memory forecasting unit 24 is configured to forecast a future memory trend based on the time series forecasting model, to periodically invoke the memory management module 20a based on the memory trend to adjust a capacity size of the off-heap memory, that is, control scaling of the off-heap memory.

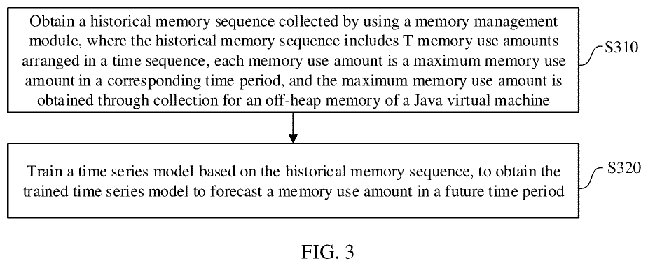

FIG. 3 is a flowchart illustrating a time series model training method, according to an embodiment. The method can be performed by any apparatus, server, or device cluster, etc. with a computing or processing capability, for example, can be performed by the time series analysis and forecasting module 20b (FIG. 2). As shown in FIG. 3, the method includes the following steps:

Step S310: Obtain a historical memory sequence collected by using a memory management module, where the historical memory sequence includes a plurality of, e.g., T, memory use amounts arranged in a time sequence, and each memory use amount is a maximum memory use amount in a corresponding time period. It can be understood that T is an integer greater than or equal to 2.

For example, a maximum memory use amount in a period (for example, 1 min or 30s) can be periodically obtained from the memory management module, to construct a plurality of historical memory sequences based on a plurality of successively obtained maximum memory use amounts. Further, it is assumed that 15 groups of data are collected, and it is set that a sequence length of the historical memory sequence is 10, that is, it is set that T=10. In this case, six historical memory sequences can be obtained by sliding a window.

Accordingly, one or more historical memory sequences can be obtained.

Step S320: Train a time series model based on the historical memory sequence, to obtain the trained time series model, also referred to herein as a well-trained time series model, to forecast a memory use amount in a future time period. It should be understood that the time series model can be implemented based on an existing algorithm, for example, a prophet model or a Holt Winter model.

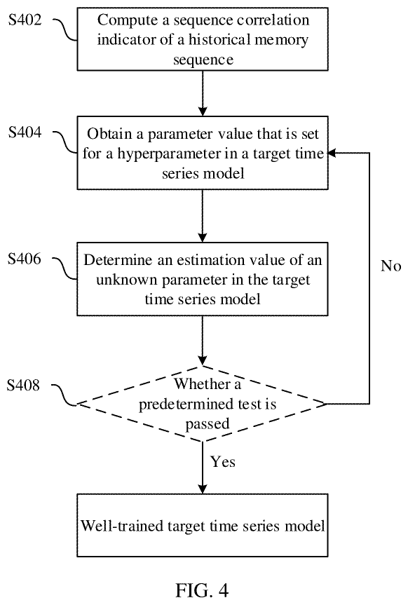

FIG. 4 is a flowchart illustrating a procedure for training the time series model, according to an embodiment. In the embodiment, the procedure for training the time series model is based on the historical memory sequence. In the following, the time series model is referred to as a target time series model or a target time series algorithm. The target time series algorithm is implemented to first find a trend rule, a seasonal rule, or a service scenario period (domain cycle) in data; and extract regular information from the data layer by layer. The remaining data has no rule or is referred to as noise. In an ideal case, the remaining data is white noise, for example, noise that satisfies a normal distribution.

As shown in FIG. 4, training the target time series model includes: Step S402: Compute a sequence correlation indicator of the historical memory sequence; Step S404: Obtain a parameter value that is set for a hyperparameter in the time series model based on an indicator computing result; Step S406: Optimize a target function based on the parameter value of the hyperparameter and the historical memory sequence, to obtain a parameter estimation value of an unknown parameter in the time series model, so as to determine the well-trained time series model. Steps S402, S404, and S406 are described in detail below.

First, in step S402, the sequence correlation indicator of the historical memory sequence is computed.

In an embodiment, in consideration that the target time series model is applied to process stable sequence data, before step S402 is performed, a stability test can be further performed on the historical memory sequence.

Further, differential transformation processing is performed on the historical memory sequence when a test result indicates that the historical memory sequence is unstable, to obtain a transformed stable memory sequence, which is used for subsequent processing. It should be understood that the stability test can be performed by using a unit root test, for example, a DF unit root test, an ADF unit root test, or a PP unit root test. One-order or multi-order differentiation can be used for the differential transformation processing based on a requirement, and each time of differentiation is subtracting an element in a current sequence from an element that is adjacent to and before the element. Subsequent processing is directly performed on the historical memory sequence when the test result indicates that the historical memory sequence is stable.

In an embodiment, the sequence correlation indicator includes an auto-correlation function (ACF), and is used to measure a degree of correlation between maximum memory use amounts in different periods.

In another embodiment, the sequence correlation indicator includes a partial auto-correlation function (PACF), and is used to measure a degree of correlation between memories in two periods of a head period and a tail period after a memory in a middle period is removed. For example, a maximum memory use amount xₜ in the t^{th} time period and a maximum memory use amount xₜ+2 in the (t+2)^{th} time period are correlated by using xₜ₊₁. The PACF is a degree of correlation between xₜ and xₜ₊₁ after an association of xₜ₊₁ is removed.

Based on the indicator computing result for the sequence correlation indicator, step S404 is performed, to obtain the parameter value that is set for the hyperparameter in the target time series model based on the indicator computing result.

For example, the target time series model can include the following components used to extract rules of the sequence from different perspectives:

$${x}_{t} = {ϕ}_{1} {x}_{t - 1} + {ϕ}_{2} {x}_{t - 2} + … + {ϕ}_{p} {x}_{t - p} + {ϵ}_{t} , {ϵ}_{t} ∼ N ( 0 , {σ}^{2} ) . \qquad Component 1$$

Meaning 1: A maximum memory use amount in a current time period can be modeled as a linear combination of maximum memory use amounts in past p time periods plus a white noise.

Objective 1: Several specific past time periods whose historical maximum memory use amounts affect the maximum memory use amount in the current time period are determined.

$${x}_{t} = {ϵ}_{t} + {θ}_{1} {ϵ}_{t - 1} + {θ}_{2} {ϵ}_{t - 2} + … + {θ}_{q} {ϵ}_{t - q} , {ϵ}_{i} ∼ N ( 0 , {σ}^{2} ) . \qquad Component 2$$

Meaning 2: A maximum memory use amount in a current time period is a linear combination of past q-order white noise.

Objective 2: Several specific past time periods whose white noise affects the maximum memory use amount in the current time period are determined, and impact of a past q-period impact effect on the maximum memory use amount in the current time period is determined.

It should be understood that seasonality of the memory sequence is not considered in the component 1 and the component 2, and further, a component 3 and a component 4 into which a seasonal parameter s is introduced can be additionally designed based on the component 1 and the component 2.

$${x}_{t} = {α}_{1} {x}_{t - s} + {α}_{1} {x}_{t - 2 s} + … + {α}_{P} {x}_{t - P * s} + {ϵ}_{t} , {ϵ}_{t} ∼ N ( 0 , {σ}^{2} ) . \qquad Component 3$$

$${x}_{t} = {β}_{t} + {β}_{1} {ϵ}_{t - s} + {β}_{2} {ϵ}_{t - 2 s} + … + {β}_{Q} {ϵ}_{t - Q * s} , {ϵ}_{i} ∼ N ( 0 , {σ}^{2} ) . \qquad Component 4$$

One of the above four components can be selected for use, or the above four components can be used in combination. The four components may be superimposed when the four components are used in combination. It should be noted that a hyperparameter in the component 1 is p, a hyperparameter in the component 2 is q, hyperparameters in the component 3 are P and s, and hyperparameters in the component 4 are Q and s. For example, when the four components are used in combination, hyperparameters of the target time series model include p, q, P, Q, and s.

The hyperparameter may be a manually set parameter. A value of the hyperparameter can be set based on a value of the sequence correlation indicator that is computed, e.g., through user observation, for example, the ACF or the PACF. Correspondingly, in this step, the value of the hyperparameter that is set based on the indicator computing result can be received, or can be determined based on the indicator computing result in a grid search method.

In addition, one group of parameter values or a plurality of groups of parameter values may be selected for the hyperparameter. For example, (p, q, P, Q, s)=(0, 4, 3, 2, 11) or (2, 3, 1, 5, 6). When a plurality of groups of parameter values are selected for the hyperparameter, to save an overall computing amount, one group of parameter values can be selected from the plurality of groups of parameter values for subsequent computing.

In an embodiment, the value of the hyperparameter can be selected based on a predetermined information criterion. In an example, the predetermined information criteria includes an Akaike information criterion (AIC), and the AIC encourages an advantage of data fitting but avoids occurrence of overfitting as far as possible. Therefore, a model with the smallest AIC value needs to be preferentially considered.

$$AIC = - 2 In ( L ) + 2 k \qquad ( 1 )$$

Here, k represents a parameter quantity of a model, and L represents a likelihood function.

In another example, the predetermined information criterion includes a Bayesian information criterion (BIC), and a group of model hyperparameter values with the smallest BIC value is also preferentially considered.

In another embodiment, a group of hyperparameter values can also be randomly selected.

Based on the above, the parameter value that is set for the hyperparameter in the target time series model can be obtained. Therefore, step S406 is performed, to optimize the target function based on the parameter value of the hyperparameter and the historical memory sequence, to obtain a parameter estimation value of an unknown parameter in the target time series model, so as to determine the well-trained target time series model.

It should be understood that the target function can be set based on an actual requirement, for example, set to a least square error function, or set to a maximum likelihood function.

For the unknown parameter, for example, ϕ₁ to ϕₚ in the component 1 are unknown parameters. In addition, x in the component 1 is a sequence element in the historical memory sequence, and Et can be obtained through random sampling from a normal distribution N (0, σ²).

Accordingly, the target time series model determined based on the parameter value of the hyperparameter and a parameter value of the unknown parameter can be obtained. Further, in an implementation, a current target time series model can be directly used as a well-trained target time series model.

In another implementation, step S408 can be further performed, to perform a predetermined test on the current target time series model, so that a target time series model that passes the test is used as the well-trained target time series model. Otherwise, step S404 is performed again, to reset the parameter value of the hyperparameter. For example, the hyperparameter is reset, based on the predetermined information criterion, to a group of parameter values in other groups of optional parameter values that are not selected. In this way, steps S406 and S408 are sequentially performed again based on the reset hyperparameter value, until a trained target time series model passes the predetermined test.

In an embodiment, the predetermined test includes a significance test for the parameter estimation value, and is used to test whether an interpretation variable (mainly the unknown parameter) exerts significant impact on an interpreted variable (mainly a forecasting variable). If the test result is that there is significant impact, the test is passed; otherwise, the test fails. For example, the significance test can be performed in a manner of t statistical test.

In another embodiment, the predetermined test includes a residual white noise test. It should be understood that a good target time series model needs to be able to extract almost all sample related information in the historical memory sequence. That is, a residual sequence needs to be a white noise sequence. On the contrary, if the residual sequence is a non-white noise sequence, it means that residual related information in the residual sequence is not extracted, and it indicates that fitting of the target time series model is not valid enough.

Specifically, a test memory sequence is forecasted by using the target time series model, to determine a residual sequence between the forecasted sequence and a corresponding label sequence; and whether the residual sequence is a white noise sequence is determined, and if the residual sequence is not a white noise sequence, it indicates that the test fails. It should be understood that the test memory sequence and the historical memory sequence can be obtained by dividing a total data set, and a division result is two mutually exclusive subsets. One subset is used to sample a test memory sequence, and the other subset is used to sample the historical memory sequence. After the label sequence is connected after the test memory sequence, a quantity t of elements in the label sequence can be set based on an actual requirement. For example, it is set that t=5.

In an embodiment, memory use amounts in the (T+1)^{th} time period to the (T+t)^{th} time period can be forecasted one by one based on a test memory sequence whose length is T. For any (T+i)^{th} time period, a memory sequence including T memory use amounts corresponding to previous T time periods is input into the target time series model, to obtain a forecasted memory use amount corresponding to the (T+i)^{th} time period.

It should be understood that the label sequence can be subtracted from a forecasted sequence, to obtain a corresponding residual sequence. In addition, whether the residual sequence is a white noise sequence can be determined in an existing manner, for example, LB statistics.

Based on the above, the residual white noise test can be implemented. It should be noted that, when the predetermined test is performed, the residual white noise test and the parameter significance test can be separately performed, or can be implemented in combination. In a case in which the residual white noise test and the parameter significance test are implemented in combination, one test is performed first and when passed, the other test is performed. In another case in which the residual white noise test and the parameter significance test are implemented in combination, two tests can be directly performed simultaneously. It should be understood that only when the two tests are passed, it is determined that a final result is “pass”; otherwise, if one test fails, it is determined that the result is “fail”.

In this way, the predetermined test of the target time series model can be implemented.

Referring back to FIG. 3, in some embodiments, the time series model trained in step S320 can be a prophet model or a Holt Winter model. The target time series model, the prophet model, etc. can be separately trained, to obtain a plurality of well-trained time series models, to be used in combination subsequently.

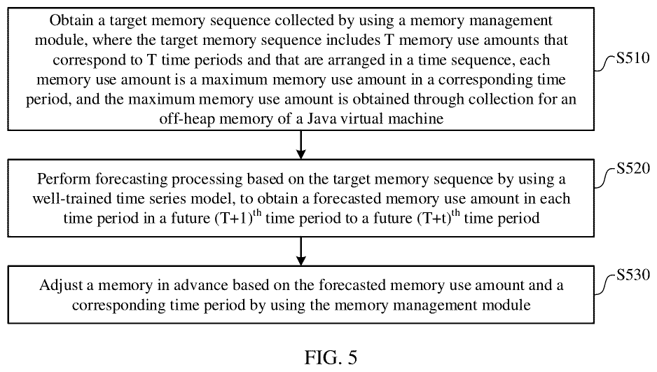

After a well-trained time series model is obtained using the method in FIG. 3, an off-heap memory of a Java virtual machine can be efficiently managed by using the time series model. FIG. 5 is a schematic diagram illustrating a memory management method, according to an embodiment. The method can be performed by any apparatus, server, or device cluster, etc. with a computing or processing capability, for example, the time series analysis and forecasting module 20b (FIG. 2). As shown in FIG. 5, the method includes the following steps.

Step S510: Obtain a target memory sequence collected by using a memory management module, where the target memory sequence includes T memory use amounts that correspond to T time periods and that are arranged in a time sequence, each memory use amount is a maximum memory use amount in a corresponding time period, and the maximum memory use amount is obtained through collection for an off-heap memory of a Java virtual machine. T is an integer greater than or equal to 2.

For example, T maximum memory use amounts corresponding to T time periods closest to a current moment can be obtained from the memory management module.

Step S520: Perform forecasting processing based on the target memory sequence by using a well-trained time series model, to obtain a forecasted memory use amount in each time period in a future (T+1)^{th} time period to a future (T+t)^{th} time period. It should be understood that t is a positive integer greater than or equal to 1.

In an embodiment, t=1. In this case, the target memory sequence is input into the well-trained time series model, to obtain a forecasted memory use amount of the (T+1)^{th} time period.

In another embodiment, t>2. In this case, memory use amounts in the (T+1)^{th} time period to the (T+t)^{th} time period can be forecasted one by one. For example, for any (T+i)^{th} time period, a memory sequence including T memory use amounts corresponding to previous T time periods is input into the time series model, to obtain a forecasted memory use amount corresponding to the (T+i)^{th} time period. In an example, the target memory sequence is first input into the time series model, to obtain a forecasted memory use amount in the (T+1)^{th} time period, and then maximum memory use amounts or forecasted memory use amounts corresponding to the 2nd time period to the (T+1)^{th} time period are input into the time series model, to obtain a forecasted memory use amount corresponding to the (T+2)^{th} time period, and so on, until a forecasted memory use amount corresponding to the (T+t)^{th} time period is obtained.

In another embodiment, after differential processing is performed on the target memory sequence, the target memory sequence is used as an input into the time series model. In this case, inverse differential processing needs to be performed on an obtained model output, to restore the maximum memory use amount.

Based on the above, t forecasted memory use amounts corresponding to future t time periods can be obtained.

Step S530: Adjust a memory in advance based on the forecasted memory use amount and a corresponding time period by using the memory management module. It should be understood that the forecasted memory use amount is a forecasted maximum memory use amount for the corresponding time period. Therefore, a memory of a corresponding size can be allocated in advance, to reduce time overheads caused by temporary memory allocation.

For example, an off-heap memory of a corresponding size is allocated at a start moment of the corresponding time period based on a forecasted maximum memory use amount of 60 future time periods (each period is 1 min).

In the memory management method described above, the time series model is used to forecast collected memory time series data, to obtain a memory use status in a future period of time, so as to help the memory management module implement dynamic scaling, thereby improving use efficiency of the off-heap memory and overall memory utilization. Achieved technical effects include: there is no need to set too many parameters to control off-heap memory management, to reduce use difficulty of a user; utilization of memory resources is improved, to prevent a memory from being too idle or too tight; and a future memory use trend is obtained by using a model and the off-heap memory is controlled, to allocate the off-heap memory in advance and to reduce time overheads caused by temporary memory allocation during use.

The memory management method described above can also be used a management scenario of any type of memory, for example, management of an on-heap memory, in addition to management of an off-heap memory. Correspondingly, the above-mentioned memory management module can be a functional module for memory management in a corresponding scenario. For example, in a scenario in which an on-heap memory of a Java virtual machine is managed, the memory management module can be integrated into the Java virtual machine.

Corresponding to the time series model training method and the memory management method, embodiments of this specification further provide a time series model training apparatus and a memory management apparatus.

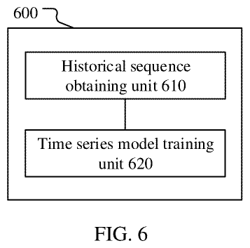

FIG. 6 is a schematic diagram illustrating a time series model training apparatus 600, according to an embodiment. As shown in FIG. 6, the apparatus 600 includes: a historical sequence obtaining unit 610, configured to obtain a historical memory sequence collected by using a memory management module, where the historical memory sequence includes T memory use amounts arranged in a time sequence, and each memory use amount is a maximum memory use amount in a corresponding time period; and a time series model training unit 620, configured to train a time series model based on the historical memory sequence, to obtain the trained time series model to forecast a memory use amount in a future time period.

In an embodiment, the maximum memory use amount is obtained through collection for an off-heap memory of a Java virtual machine.

In an embodiment, the time series model training unit 620 is further configured to: compute a sequence correlation indicator of the historical memory sequence, and obtain a parameter value that is set for a hyperparameter in the time series model based on an indicator computing result; and optimize a target function based on the parameter value of the hyperparameter and the historical memory sequence, to obtain a parameter estimation value of an unknown parameter in the time series model, so as to determine the well-trained time series model.

In an embodiment, the time series model training unit 620 is further configured to: before computing the sequence correlation indicator of the historical memory sequence, perform a stability test on the historical memory sequence; and perform differential transformation processing on the historical memory sequence when a test result indicates that the historical memory sequence is unstable.

In an embodiment, the time series model training unit 620 is specifically configured to: receive a plurality of groups of optional parameter values that are input for the hyperparameter in the time series model based on the indicator computing result; and set the hyperparameter to a first group of parameter values in the plurality of groups of optional parameter values based on a predetermined information criterion.

In an embodiment, the time series model training unit 620 is further configured to: perform a predetermined test on the time series model; and when the test fails, set the hyperparameter to a second group of parameter values in the plurality of groups of optional parameter values based on the information criterion, and re-determine the parameter estimation value of the unknown parameter in the time series model based on the second group of parameter values. For example, the predetermined test includes a significance test on the parameter estimation value, or includes: forecasting a test memory sequence by using the time series model, and determining a residual sequence between the forecasted sequence and a corresponding label sequence; and determining whether the residual sequence is a white noise sequence, and if the residual sequence is not a white noise sequence, indicating that the test fails.

In an embodiment, the time series model training unit 620 is further configured to separately train a plurality of time series models based on the historical memory sequence. The plurality of time series models include a prophet model or a Holt Winter model.

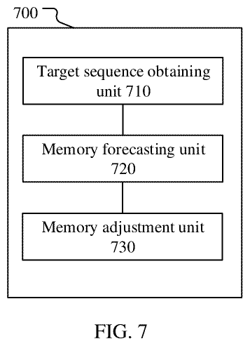

FIG. 7 is a schematic diagram illustrating a memory management apparatus 700, according to an embodiment. As shown in FIG. 7, the apparatus 700 includes: a target sequence obtaining unit 710, configured to obtain a target memory sequence collected by using a memory management module, where the target memory sequence includes T memory use amounts that correspond to T time periods and that are arranged in a time sequence, and each memory use amount is a maximum memory use amount in a corresponding time period; a memory forecasting unit 720, configured to perform forecasting processing based on the target memory sequence by using a well-trained time series model, to obtain a forecasted memory use amount in each time period in a future (T+1)^{th} time period to a future (T+t)^{th} time period; and a memory adjustment unit 730, configured to adjust a memory in advance based on the forecasted memory use amount and a corresponding time period by using the memory management module.

In an embodiment, the maximum memory use amount is obtained through collection for an off-heap memory of a Java virtual machine.

In an embodiment, the memory forecasting unit 720 is specifically configured to forecast memory use amounts in the (T+1)^{th} time period to the (T+t)^{th} time period one by one. For any (T+i)^{th} time period, a memory sequence including T memory use amounts corresponding to previous T time periods is input into the time series model, to obtain a forecasted memory use amount corresponding to the (T+i)^{th} time period.

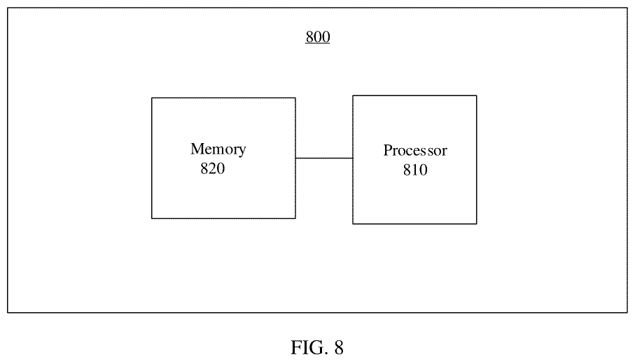

FIG. 8 is a schematic diagram illustrating an apparatus 800, according to an embodiment. The apparatus 800 can be deployed in any device, platform, or device cluster with a data storage, computing, or processing capability, and can implement the time series model training apparatus 600 (FIG. 6) or the memory management apparatus 700 (FIG. 7). As shown in FIG. 8, the apparatus 800 includes: one or more processors 810 and one or more memories 820 storing instructions executable by the one or more processors 810. The one or more processors 810 are configured to perform the time series model training method or the memory management method described above.

Embodiments of this specification further provides a non-transitory computer-readable storage medium. The computer-readable storage medium stores a computer program, and when the computer program is executed by one or more processors, the one or more processors are caused to perform the time series model training method or the memory management method described above.

In the above embodiments of this specification, each module or unit can be implemented by hardware, software, or a combination thereof. When the module or unit is implemented by software, the software can be stored in a computer-readable medium or transmitted as one or more instructions to implement corresponding functions.

In the above described methods and apparatuses, a time series model is used to forecast collected off-heap memory time series data, to obtain an off-heap memory use status in a future period of time, so as to help an off-heap memory management module implement dynamic scaling, thereby improving use efficiency of the off-heap memory and overall memory utilization.

It should be understood that the above descriptions are merely example embodiments of the present disclosure, and are not intended to limit the protection scope of this disclosure. Any modification, equivalent replacement, improvement, etc. made based on the embodiments of this disclosure shall fall within the protection scope of this disclosure.

What is claimed is:

1. A time series model training method, comprising:
obtaining a historical memory sequence collected by using a memory management module, wherein the historical memory sequence comprises a plurality of memory use amounts arranged in a time sequence, each memory use amount is a maximum memory use amount in a corresponding time period, and the maximum memory use amount is obtained through collection for an off-heap memory of a Java virtual machine; and
training a time series model based on the historical memory sequence, to obtain the trained time series model to forecast a memory use amount in a future time period.

2. The method according to claim 1, wherein the training the time series model based on the historical memory sequence comprises:
computing a sequence correlation indicator of the historical memory sequence, and obtaining a parameter value that is set for a hyperparameter in the time series model based on an indicator computing result; and
optimizing a target function based on the parameter value of the hyperparameter and the historical memory sequence, to obtain a parameter estimation value of an unknown parameter in the time series model, so as to determine the trained time series model.

3. The method according to claim 2, wherein before the computing the sequence correlation indicator of the historical memory sequence, the method further comprises:
performing a stability test on the historical memory sequence; and
performing differential transformation processing on the historical memory sequence when a test result indicates that the historical memory sequence is unstable.

4. The method according to claim 2, wherein the obtaining the parameter value that is set for the hyperparameter in the time series model based on an indicator computing result comprises:
receiving a plurality of groups of optional parameter values that are input for the hyperparameter in the time series model based on the indicator computing result; and
setting the hyperparameter to a first group of parameter values in the plurality of groups of optional parameter values based on a predetermined information criterion.

5. The method according to claim 4, wherein the determining the trained time series model comprises:
performing a predetermined test on the time series model; and
when the test fails, setting the hyperparameter to a second group of parameter values in the plurality of groups of optional parameter values based on the information criterion, and re-determining the parameter estimation value of the unknown parameter in the time series model based on the second group of parameter values.

6. The method according to claim 5, wherein the predetermined test comprises a significance test on the parameter estimation value.

7. The method according to claim 5, wherein the predetermined test comprises:
forecasting a test memory sequence by using the time series model, and determining a residual sequence between the forecasted test memory sequence and a corresponding label sequence; and
determining whether the residual sequence is a white noise sequence, and if the residual sequence is not a white noise sequence, indicating that the test fails.

8. The method according to claim 1, wherein the training the time series model based on the historical memory sequence comprises:
separately training a plurality of time series models based on the historical memory sequence, wherein the plurality of time series models comprise at least one of a prophet model or a Holt Winter model.

9. A memory management method, comprising:
obtaining a target memory sequence collected by using a memory management module, wherein the target memory sequence comprises T memory use amounts that correspond to T time periods and that are arranged in a time sequence, each memory use amount is a maximum memory use amount in a corresponding time period, and the maximum memory use amount is obtained through collection for an off-heap memory of a Java virtual machine;
performing forecasting processing based on the target memory sequence by using a trained time series model, to obtain a forecasted memory use amount in each time period in a future (T+1)^{th} time period to a future (T+t)^{th} time period; and
adjusting a memory in advance based on the forecasted memory use amount and a corresponding time period by using the memory management module,
wherein T is an integer greater than or equal to 2, and t is an integer greater than or equal to 1.

10. The method according to claim 9, wherein the performing forecasting processing based on the target memory sequence by using the trained time series model, to obtain the forecasted memory use amount in each time period in the future (T+1)^{th} time period to the future (T+t)^{th} time period comprises:
forecasting memory use amounts in the (T+1)^{th} time period to the (T+t)^{th} time period one by one, wherein for any (T+i)^{th} time period, a memory sequence comprising T memory use amounts corresponding to previous T time periods is input into the trained time series model, to obtain a forecasted memory use amount corresponding to the (T+i)^{th} time period.

11. A time series model training apparatus, comprising:
one or more processors; and
one or more memories storing instructions executable by the one or more processors;
wherein the one or more processors are configured to:
obtain a historical memory sequence collected by using a memory management module, wherein the historical memory sequence comprises a plurality of memory use amounts arranged in a time sequence, each memory use amount is a maximum memory use amount in a corresponding time period, and the maximum memory use amount is obtained through collection for an off-heap memory of a Java virtual machine; and
train a time series model based on the historical memory sequence, to obtain the trained time series model to forecast a memory use amount in a future time period.

12. The time series model training apparatus according to claim 11, wherein the one or more processors are further configured to:
compute a sequence correlation indicator of the historical memory sequence, and obtain a parameter value that is set for a hyperparameter in the time series model based on an indicator computing result; and
optimize a target function based on the parameter value of the hyperparameter and the historical memory sequence, to obtain a parameter estimation value of an unknown parameter in the time series model, so as to determine the trained time series model.

13. The time series model training apparatus according to 12, wherein before the computing the sequence correlation indicator of the historical memory sequence, the one or more processors are further configured to:
perform a stability test on the historical memory sequence; and
perform differential transformation processing on the historical memory sequence when a test result indicates that the historical memory sequence is unstable.

14. The time series model training apparatus according to claim 12, wherein the one or more processors are further configured to:
receive a plurality of groups of optional parameter values that are input for the hyperparameter in the time series model based on the indicator computing result; and
set the hyperparameter to a first group of parameter values in the plurality of groups of optional parameter values based on a predetermined information criterion.

15. The time series model training apparatus according to claim 14, wherein the one or more processors are further configured to:
perform a predetermined test on the time series model; and
when the test fails, set the hyperparameter to a second group of parameter values in the plurality of groups of optional parameter values based on the information criterion, and re-determine the parameter estimation value of the unknown parameter in the time series model based on the second group of parameter values.

16. The time series model training apparatus according to claim 15, wherein the predetermined test comprises a significance test on the parameter estimation value.

17. The time series model training apparatus according to claim 15, wherein the predetermined test comprises:
forecasting a test memory sequence by using the time series model, and determining a residual sequence between the forecasted test memory sequence and a corresponding label sequence; and
determining whether the residual sequence is a white noise sequence, and if the residual sequence is not a white noise sequence, indicating that the test fails.

18. The time series model training apparatus according to claim 11, wherein the one or more processors are further configured to:
separately train a plurality of time series models based on the historical memory sequence, wherein the plurality of time series models comprise at least one of a prophet model or a Holt Winter model.

19. A memory management apparatus, comprising:
one or more processors; and
one or more memories storing instructions executable by the one or more processors;
wherein the one or more processors are configured to:
obtain a target memory sequence collected by using a memory management module, wherein the target memory sequence comprises T memory use amounts that correspond to T time periods and that are arranged in a time sequence, each memory use amount is a maximum memory use amount in a corresponding time period, and the maximum memory use amount is obtained through collection for an off-heap memory of a Java virtual machine;
perform forecasting processing based on the target memory sequence by using a trained time series model, to obtain a forecasted memory use amount in each time period in a future (T+1)^{th} time period to a future (T+t)^{th} time period; and
adjust a memory in advance based on the forecasted memory use amount and a corresponding time period by using the memory management module,
wherein T is an integer greater than or equal to 2, and t is an integer greater than or equal to 1.

20. The memory management apparatus according to claim 19, wherein the one or more processors are further configured to:
forecast memory use amounts in the (T+1)^{th} time period to the (T+t)^{th} time period one by one, wherein for any (T+i)^{th} time period, a memory sequence comprising T memory use amounts corresponding to previous T time periods is input into the trained time series model, to obtain a forecasted memory use amount corresponding to the (T+i)^{th} time period.
